(19) United States
(12) Patent Application Publication
(10) Pub. No.: US 2019/0327655 A1
(43) Pub. Date: Oct. 24, 2019

(54) Methods And Apparatus For Selecting Large-Bandwidth Cell In Mobile Communications

(71) Applicant: MediaTek Inc., Hsinchu City (TW)

(72) Inventors: Tsung-Ming Lee, Hsinchu City (TW); Chun-Pin Chen, Hsinchu City (TW); Lung-Wen Chen, Hsinchu City (TW); Sian-Jheng Wong, Hsinchu City (TW)

(21) Appl. No.: 16/140,704

(22) Filed: Sep. 25, 2018

Related U.S. Application Data
(60) Provisional application No. 62/661,226, filed on Apr. 23, 2018.

(51) Int. Cl. H04W 36/08; H04W 36/00; H04W 36/30; H04W 24/10

(52) U.S. Cl. CPC H04W 36/08; H04W 24/10; H04W 36/30; H04W 36/0094

(57) ABSTRACT

Various solutions for selecting large-bandwidth cell with respect to user equipment and network apparatus in mobile communications are described. An apparatus may measure a first cell. The apparatus may measure a second cell. The apparatus may add an offset value to a measurement report of the second cell. The apparatus may transmit the measurement report of the second cell to a serving cell. A second bandwidth of the second cell may be greater than a first bandwidth of the first cell.

### CROSS REFERENCE TO RELATED PATENT APPLICATION(S)

The present disclosure is part of a non-provisional application claiming the priority benefit of U.S. Patent Application No. 62/661,226, filed on 23 Apr. 2018, the content of which is incorporated by reference in its entirety.

### TECHNICAL FIELD

The present disclosure is generally related to mobile communications and, more particularly, to selecting large-bandwidth cell with respect to user equipment and network apparatus in mobile communications.

### BACKGROUND

Unless otherwise indicated herein, approaches described in this section are not prior art to the claims listed below and are not admitted as prior art by inclusion in this section.

In Long-Term Evolution (LTE), new radio (NR), or any other communication system, a network node of the communication system may have an operating bandwidth for downlink and/or uplink transmissions. The UE may be able to connect to at least one of the network nodes for data transmissions. Generally, the larger bandwidth cell the UE connects to, the higher data throughput the UE may have.

However, the UE may be configured to select the network node based on measurement results. For example, assuming that two network nodes (e.g., node A and node B) may be measured. The node A may have a larger bandwidth, and the node B may have a smaller bandwidth. In a case that the UE selects or handovers to the node B rather than the node A based on the measurement results, the UE may suffer from lower system bandwidth.

Accordingly, whether the UE can camp on a large-bandwidth network node may affect the maximum data throughput and the user experiences. It is needed to provide proper mechanisms to increase probabilities for the UE to camp on a large-bandwidth network node.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to selecting large-bandwidth cell with respect to user equipment and network apparatus in mobile communications.

In one aspect, a method may involve an apparatus measuring a first cell. The method may also involve the apparatus measuring a second cell. The method may further involve the apparatus adding an offset value to a measurement report of the second cell. The method may further involve the apparatus transmitting the measurement report of the second cell to a serving cell. A second bandwidth of the second cell may be greater than a first bandwidth of the first cell.

In one aspect, a method may involve an apparatus determining a first bandwidth of a first cell. The method may also involve the apparatus determining a second bandwidth of a second cell. The method may further involve the apparatus adjusting a cell search order according to the first bandwidth and the second bandwidth. The method may further involve the apparatus performing a cell selection according to the cell search order.

In one aspect, a method may involve an apparatus performing a cell reselection evaluation of a first cell. The method may also involve the apparatus performing the cell reselection evaluation of a second cell. The method may further involve the apparatus adding an offset value to the cell reselection evaluation of the second cell. The method may further involve the apparatus performing a cell reselection to the second cell. A second bandwidth of the second cell may be greater than a first bandwidth of the first cell.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scheme under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to selecting large-bandwidth network node with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

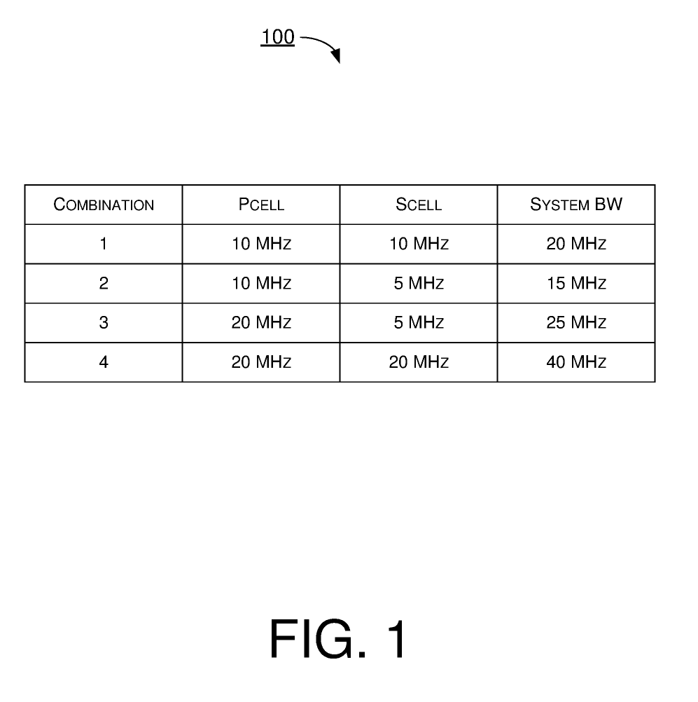

FIG. 1 illustrates an example scenario 100 under schemes in accordance with implementations of the present disclosure. Scenario 100 involves a UE and a plurality of cells, which may be a part of a wireless communication network (e.g., an LTE network, an LTE-Advanced network, an LTE-Advanced Pro network, a 5G network, an NR network, an IoT network or an NB-IoT network). Each of the cells may have an operating bandwidth (BW) for downlink and/or uplink transmissions. The UE may be able to connect to at least one of the cells as a primary cell (Pcell), and/or connect to at least one of the cells as a secondary cell (Scell). Under carrier aggregation (CA) or dual connectivity (DC) configurations, the UE may be configured to connect to a first cell (e.g., Pcell) and a second cell (e.g., Scell). The first cell may be operated in a first bandwidth. The second cell may be operated in a second bandwidth. The total bandwidth or the system bandwidth configured to the UE may be the combination of the first bandwidth and the second bandwidth. For example, as shown in FIG. 1, in combination 1, the system bandwidth (e.g., 20 MHz) is the sum of the bandwidth of the Pcell (e.g., 10 MHz) and the bandwidth of the Scell (e.g., 10 MHz). Generally, the larger system bandwidth the UE connects to, the higher data throughput the UE may have.

In some scenarios, the UE may be configured to measure the cells. For example, two cells (e.g., cell A and cell B) can be measured. The cell A may have a larger bandwidth 20 MHz, and the cell B may have a smaller bandwidth 10 MHz. In a case that the UE selects or handovers to the cell B rather than the cell A, the UE may suffer from lower system bandwidth. Although the UE may support CA combination, the UE may have chances to get more system bandwidth in a case that the UE can connect to a larger bandwidth cell. For example, as shown in FIG. 1, the system bandwidth of combination 3 is greater than the system bandwidth of combination 1.

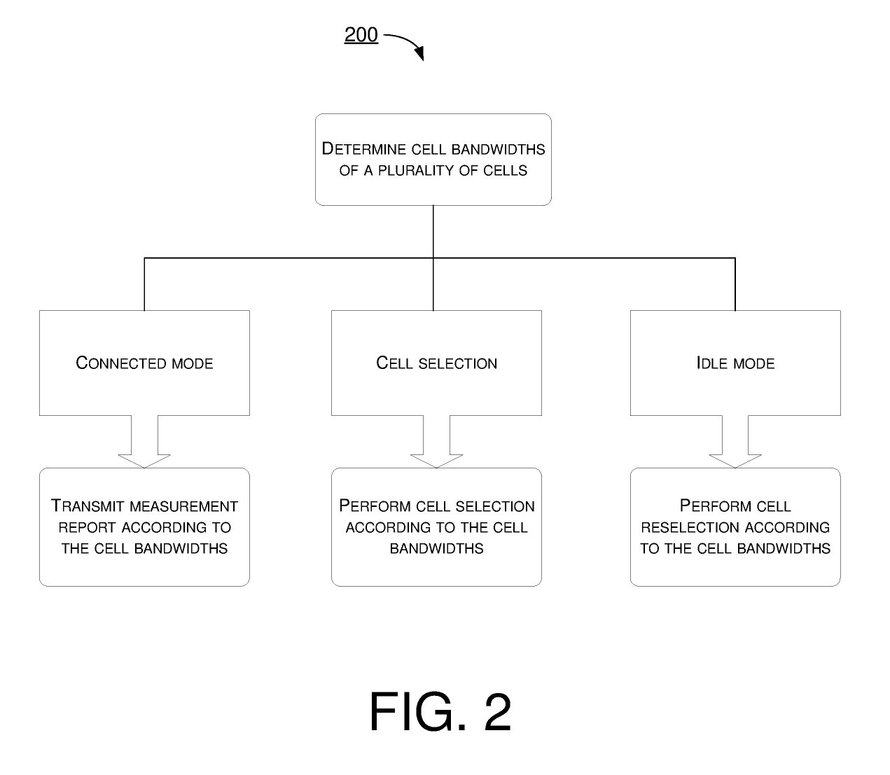

FIG. 2 illustrates an example scheme 200 under schemes in accordance with implementations of the present disclosure. Scheme 200 involves a UE and a plurality of cells, which may be a part of a wireless communication network (e.g., an LTE network, an LTE-Advanced network, an LTE-Advanced Pro network, a 5G network, an NR network, an IoT network or an NB-IoT network). The UE may be configured to determine the bandwidths of a plurality of cells. The UE may use variant ways to acquire the bandwidth information of each cell.

Specifically, the UE may be configured to determine the bandwidth of the cell by the measurement bandwidth configured by a serving cell. The serving cell may configure the UE to measure a neighbor cell. The serving cell may assign a measurement bandwidth for the UE to perform the measurement. The UE may consider the measurement bandwidth as the operating bandwidth of the neighbor cell.

Alternatively, the UE may be configured to determine the bandwidth of the cell by pre-stored bandwidth information. When the UE camps on a cell, the UE may be able to acquire/know the bandwidth information of the camped cell. The UE may be configured to store the bandwidth information of the camped cell. When the UE needs to determine the bandwidth of the camped cell, the UE may directly use the stored bandwidth information of the camped cell.

Alternatively, the UE may be configured to determine the bandwidth of the cell by a pre-determined measurement bandwidth. The pre-determined measurement bandwidth may be, for example and without limitation, 10 MHz. When the UE needs to determine the bandwidth of the cell, the UE may directly use 10 MHz to measure the cell. In a case that the cell is measurable, the UE may determine that the bandwidth of the cell is greater than 10 MHz. In a case that the cell is un-measurable, the UE may determine that the bandwidth of the cell is less than 10 MHz. Accordingly, the UE may use the pre-determined measurement bandwidth to determine whether the bandwidth of the cell is greater than or less than the pre-determined measurement bandwidth.

Alternatively, the UE may be configured to determine the bandwidth of the cell by a reference signal transmitted by the cell. The cell may be configured to broadcast reference signals including, for example and without limitation, cell reference signal (CRS). The UE may be configured to detect the bandwidth of the CRS. The UE may consider the bandwidth used by the CRS as the operating bandwidth of the cell.

After determining the bandwidths of a plurality of cells, the UE may be configured to try to camp on the cell with larger bandwidth in accordance with implementations of the present disclosure. The UE may be configured to use different schemes for camping on the larger bandwidth cell when operated in different states. As shown in FIG. 2, the UE may be operated in three different states including a connected mode, a cell selection stage, and an idle mode. When the UE is turned on or switched back from the flight mode, the UE may be operated in the cell selection stage. When the UE establishes a radio resource control (RRC) connection with a cell, the UE may be operated in a connected mode. When the UE has no data to transmit or receive, the UE may release the RRC connection and enter into an idle mode.

In the connected mode, the UE may be configured to transmit the measurement report according to the cell bandwidths. Specifically, when the UE operates in the connected mode, the serving cell of the UE may configure the UE to measure the neighbor cells. For example, the UE may be configured to measure a first neighbor cell and a second neighbor cell. The UE may be configured to measure the reference symbol received power (RSRP) or reference signal received quality (RSRQ) of the neighbor cell. The UE may further be configured to determine a first bandwidth of the first cell, and a second bandwidth of the second cell. The UE may be configured to determine the first bandwidth and the second bandwidth by using the aforementioned methods. For example, the UE may determine the first bandwidth and the second bandwidth according to the measurement bandwidths configured by the serving cell, the pre-stored bandwidth information, the pre-determined measurement bandwidth, or the reference signals.

In a case that the second bandwidth of the second cell is greater than the first bandwidth of the first cell, the UE may prefer to handover to the second cell rather than the first cell. Specifically, the UE may be configured add an offset value to the measurement report of the second cell. For example, the UE may add an offset value to the measured RSRP or RSRQ of the second cell. Then, the measurement report of the second cell may have a higher RSRP or RSRP than the measurement report of the first cell. The UE may be configured to transmit the measurement report of the first cell and the measurement report of the second cell to the serving cell. Since the RSRP or RSRQ in the measurement report of the second cell is greater than the RSRP or RSRQ in the measurement report of the first cell, the serving cell may configure the UE to handover to the second cell. Accordingly, the UE may have greater chances to handover to the neighbor cell with larger bandwidth.

In some implementations, the measurement report may comprise, for example and without limitation, an A3 measurement report, an A4 measurement report, or an A5 measurement report. The UE may add the offset value to the A3 measurement report or the A4 measurement report. For the A5 measurement report, the UE may be configured to add offset/2 in A5 condition 1 and add −offset/2 in A5 condition 2. The UE may also be able to increase the measured value of a cell with a large bandwidth, and/or decrease the measured value of a cell with small bandwidth in other measurement reports.

In some implementations, the UE may be configured to pend or block the measurement report of small bandwidth cell and transmit the measurement report of large-bandwidth cell firstly. For example, the UE may be configured to pend or block the measurement report of the first cell without transmitting the measurement report of the first cell to the serving cell. The UE may only transmit the measurement report of the second cell to the serving cell. Accordingly, the serving cell may only receive the measurement report of the cell with a large bandwidth. The serving cell may only configure the UE to handover to the cell having the received measurement report.

In the cell selection stage, the UE may be configured to perform the cell selection according to the cell bandwidths. Specifically, when the UE is powered on, the UE may be configured to search suitable cell to camp on. The UE may need to determine a cell search order for performing the cell search procedure. The UE may also determine the bandwidth of each cell. The UE may be configured to determine the cell search order according to the bandwidth of each cell. For example, the UE may be configured to determine a first bandwidth of a first cell, and a second bandwidth of a second cell. The UE may be configured to determine the first bandwidth and the second bandwidth by using the aforementioned methods. For example, the UE may determine the first bandwidth and the second bandwidth according to the measurement bandwidths configured by the serving cell, the pre-stored bandwidth information, the pre-determined measurement bandwidth, or the reference signals.

In a case that the second bandwidth of the second cell is greater than the first bandwidth of the first cell, the UE may be configured to adjust the cell search order according to the first bandwidth and the second bandwidth. In a case that the second bandwidth is greater than the first bandwidth, the UE may adjust the priority of the second cell to be greater than the priority of the first cell in the cell search order. The UE may be configured to perform the cell selection according to the cell search order. Accordingly, the large-bandwidth cell may be searched prior to the small bandwidth cell. The UE may have greater chances to select the large-bandwidth cell in the cell selection stage.

In the idle mode, the UE may be configured to perform cell reselection according to the cell bandwidths. Specifically, when the UE operates in the idle mode, the UE may be configured to perform the cell reselection evaluation for a plurality of neighbor cells. The cell reselection evaluation may comprise an S-value evaluation. For example, the UE may be configured to perform the S-value evaluation for a first cell and a second cell. The UE may further be configured to determine a first bandwidth of the first cell, and a second bandwidth of the second cell. The UE may be configured to determine the first bandwidth and the second bandwidth by using the aforementioned methods. For example, the UE may determine the first bandwidth and the second bandwidth according to the measurement bandwidths configured by the serving cell, the pre-stored bandwidth information, the pre-determined measurement bandwidth, or the reference signals.

In a case that the second bandwidth of the second cell is greater than the first bandwidth of the first cell, the UE may prefer to reselect to the second cell rather than the first cell. Specifically, the UE may be configured add an offset value to the S-value evaluation of the second cell. Then, the S-value evaluation of the second cell may be greater than the S-value evaluation of the first cell. Since the cell reselection evaluation of the second cell is greater than the cell reselection evaluation of the first cell, the UE may perform the cell reselection to reselect to the second cell. Accordingly, the UE may have greater chances to reselect to the cell with larger bandwidth.

In some implementations, the UE may be configured to pend or block the cell reselection candidate with small bandwidth and try the cell reselection candidate with a large bandwidth firstly. Alternatively, the UE may decrease the S-value evaluation result of the small bandwidth cell or lower the priority of the small bandwidth cell when performing the cell reselection. For example, the UE may be configured to pend or block the first cell without re-selecting to the first cell. The UE may only try the cell reselection to the second cell. Accordingly, the UE may only consider the cell reselection candidate with a large bandwidth. The UE may have greater chances to reselect to the cell with larger bandwidth.

In some implementations, the UE may be configured to determine whether the UE is operated in high date transmission. The UE may be configured to estimate the data amount scheduled to be transmitted or received. For example, in the connected mode, the UE may determine whether the ongoing data throughput is larger. In the idle mode, the UE may determine whether the data throughput before entering into the idle mode is large. In a case that the data amount is large for transmission (e.g., video stream), the UE may be configured to trigger the aforementioned schemes for camping on a large-bandwidth cell. In a case that the data amount is small (e.g., voice call), the UE may be configured to use normal operations without considering the cell bandwidth. The high data indication may be determined by UE itself, or indicated by a network node.

### Illustrative Implementations

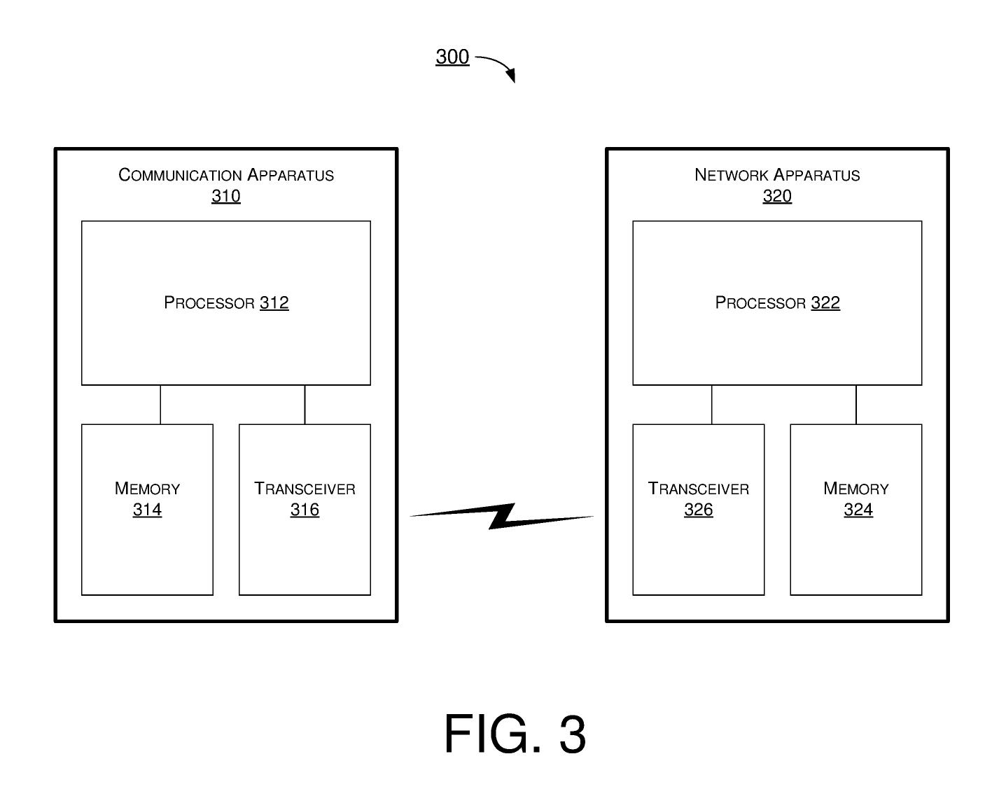

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to selecting large-bandwidth cell with respect to user equipment and network apparatus in wireless communications, including scheme 200 described above as well as processes 400, 500 and 600 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may be configured to determine a bandwidth of a network apparatus by the measurement bandwidth configured by network apparatus 320. Processor 322 may configure communication apparatus 310 to measure a neighbor network apparatus. Processor 322 may assign a measurement bandwidth for processor 312 to perform the measurement. Processor 312 may consider the measurement bandwidth as the operating bandwidth of the neighbor network apparatus.

In some implementations, processor 312 may be configured to determine the bandwidth of a network apparatus by pre-stored bandwidth information. When communication apparatus 310 camps on a network apparatus, processor 312 may be able to acquire/know the bandwidth information of the camped network apparatus. Processor 312 may be configured to store the bandwidth information of the camped network apparatus in memory 314. When processor 312 needs to determine the bandwidth of the camped network apparatus, processor 312 may directly use the stored bandwidth information of the camped network apparatus.

In some implementations, processor 312 may be configured to determine the bandwidth of a network apparatus by a pre-determined measurement bandwidth. The pre-determined measurement bandwidth may be, for example and without limitation, 10 MHz. When processor 312 needs to determine the bandwidth of the network apparatus, processor 312 may directly use 10 MHz to measure the network apparatus. In a case that the network apparatus is measurable, processor 312 may determine that the bandwidth of the cell is greater than 10 MHz. In a case that the network apparatus is un-measurable, processor 312 may determine that the bandwidth of the cell is less than 10 MHz. Accordingly, processor 312 may use the pre-determined measurement bandwidth to determine whether the bandwidth of the network apparatus is greater than or less than the pre-determined measurement bandwidth.

In some implementations, processor 312 may be configured to determine the bandwidth of a network apparatus by a reference signal transmitted by the network apparatus. The network apparatus may be configured to broadcast reference signals including, for example and without limitation, CRS. Processor 312 may be configured to detect the bandwidth of the CRS. Processor 312 may consider the bandwidth used by the CRS as the operating bandwidth of the network apparatus.

In some implementations, after determining the bandwidths of a plurality of network apparatus, processor 312 may be configured to try to camp on the network apparatus with larger bandwidth. In the connected mode, processor 312 may be configured to transmit the measurement report according to the bandwidths. Specifically, when processor 312 operates in the connected mode, network apparatus 320 may configure processor 312 to measure the neighbor network apparatus. For example, processor 312 may be configured to measure a first neighbor network apparatus and a second neighbor network apparatus. Processor 312 may be configured to measure the RSRP or RSRQ of the neighbor network apparatus. Processor 312 may further be configured to determine a first bandwidth of the first network apparatus, and a second bandwidth of the second network apparatus. Processor 312 may be configured to determine the first bandwidth and the second bandwidth by using the aforementioned methods. For example, processor 312 may determine the first bandwidth and the second bandwidth according to the measurement bandwidths configured by network apparatus 320, the pre-stored bandwidth information, the pre-determined measurement bandwidth, or the reference signals.

In some implementations, in a case that the second bandwidth of the second network apparatus is greater than the first bandwidth of the first network apparatus, processor may prefer to handover to the second network apparatus rather than the first network apparatus. Specifically, processor 312 may be configured add an offset value to the measurement report of the second network apparatus. For example, processor 312 may add an offset value to the measured RSRP or RSRQ of the second network apparatus. Then, the measurement report of the second network apparatus may have a higher RSRP or RSRP than the measurement report of the first network apparatus. Processor 312 may be configured to transmit, via transceiver 316, the measurement report of the first network apparatus and the measurement report of the second network apparatus to network apparatus 320. Since the RSRP or RSRQ in the measurement report of the second network apparatus is greater than the RSRP or RSRQ in the measurement report of the first network apparatus, network apparatus 320 may configured processor 312 to handover to the second network apparatus. Accordingly, processor 312 may have greater chances to handover to the neighbor network apparatus with larger bandwidth.

In some implementations, processor 312 may add the offset value to the A3 measurement report or the A4 measurement report. For the A5 measurement report, processor 312 may be configured to add offset/2 in A5 condition 1 and add −offset/2 in A5 condition 2. Processor 312 may also be able to increase the measured value of a network apparatus with a large bandwidth, and/or decrease the measured value of a network apparatus with small bandwidth in other measurement reports.

In some implementations, processor 312 may be configured to pend or block the measurement report of small bandwidth network apparatus and transmit the measurement report of large-bandwidth network apparatus firstly. For example, processor 312 may be configured to pend or block the measurement report of the first network apparatus without transmitting the measurement report of the first network apparatus to network apparatus 320. Processor 320 may only transmit the measurement report of the second network apparatus to network apparatus 320. Accordingly, network apparatus 320 may only receive the measurement report of the network apparatus with a large bandwidth. Network apparatus 320 may only configure processor 312 to handover to the network apparatus having the received measurement report.

In some implementations, in the cell selection stage, processor 312 may be configured to perform the cell selection according to the bandwidths. Specifically, when communication apparatus 310 is powered on, processor 312 may be configured to search suitable network apparatus to camp on. Processor 312 may need to determine a search order for performing the cell search procedure. Processor 312 may also determine the bandwidth of each network apparatus. Processor 312 may be configured to determine the search order according to the bandwidth of each network apparatus. For example, processor 312 may be configured to determine a first bandwidth of a first network apparatus, and a second bandwidth of a second network apparatus. Processor 312 may be configured to determine the first bandwidth and the second bandwidth by using the aforementioned methods. For example, processor 312 may determine the first bandwidth and the second bandwidth according to the measurement bandwidths configured by network apparatus 320, the pre-stored bandwidth information, the pre-determined measurement bandwidth, or the reference signals.

In some implementations, in a case that the second bandwidth is greater than the first bandwidth, processor 312 may be configured to adjust the search order according to the first bandwidth and the second bandwidth. In a case that the second bandwidth is greater than the first bandwidth, the UE may adjust the priority of the second network apparatus to be greater than the priority of the first network apparatus in the search order. Processor 312 may be configured to perform the cell selection according to the search order. Accordingly, the large-bandwidth network apparatus may be searched prior to the small bandwidth network apparatus. Processor 312 may have greater chances to select the large-bandwidth network apparatus in the cell selection stage.

In some implementations, in the idle mode, processor 312 may be configured to perform cell reselection according to the bandwidths. Specifically, when processor 312 operates in the idle mode, processor 312 may be configured to perform the cell reselection evaluation for a plurality of neighbor network apparatus. For example, processor 312 may be configured to perform the S-value evaluation for a first network apparatus and a second network apparatus. Processor 312 may further be configured to determine a first bandwidth of the first network apparatus, and a second bandwidth of the second network apparatus. Processor 312 may be configured to determine the first bandwidth and the second bandwidth by using the aforementioned methods. For example, processor 312 may determine the first bandwidth and the second bandwidth according to the measurement bandwidths configured by network apparatus 320, the pre-stored bandwidth information, the pre-determined measurement bandwidth, or the reference signals.

In some implementations, in a case that the second bandwidth is greater than the first bandwidth, processor 312 may prefer to reselect to the second network apparatus rather than the first network apparatus. Specifically, processor 312 may be configured add an offset value to the S-value evaluation of the second network apparatus. Then, the S-value evaluation of the second network apparatus may be greater than the S-value evaluation of the first network apparatus. Since the cell reselection evaluation of the second network apparatus is greater than the cell reselection evaluation of the first network apparatus, processor 312 may perform the cell reselection to reselect to the second network apparatus. Accordingly, processor 312 may have greater chances to reselect to the network apparatus with larger bandwidth.

In some implementations, processor 312 may be configured to pend or block the cell reselection candidate with small bandwidth and try the cell reselection candidate with a large bandwidth firstly. Alternatively, processor 312 may decrease the S-value evaluation result of the small bandwidth network apparatus or lower the priority of the small bandwidth network apparatus when performing the cell reselection. For example, processor 312 may be configured to pend or block the first network apparatus without re-selecting to the first network apparatus. Processor 312 may only try the cell reselection to the second network apparatus. Accordingly, processor 312 may only consider the cell reselection candidate with a large bandwidth. Processor 312 may have greater chances to reselect to the network apparatus with larger bandwidth.

In some implementations, processor 312 may be configured to determine whether communication apparatus 310 is operated in high date transmission. Processor 312 may be configured to estimate the data amount scheduled to be transmitted or received. For example, in the connected mode, processor 312 may determine whether the ongoing data throughput is larger. In the idle mode, processor 312 may determine whether the data throughput before entering into the idle mode is large. In a case that the data amount is large for transmission (e.g., video stream), processor 312 may be configured to trigger the aforementioned schemes for camping on a large-bandwidth network apparatus. In a case that the data amount is small (e.g., voice call), processor 312 may be configured to use normal operations without considering the bandwidth. The high data indication may be determined by processor 312 itself or indicated by network apparatus 320.

### Illustrative Processes

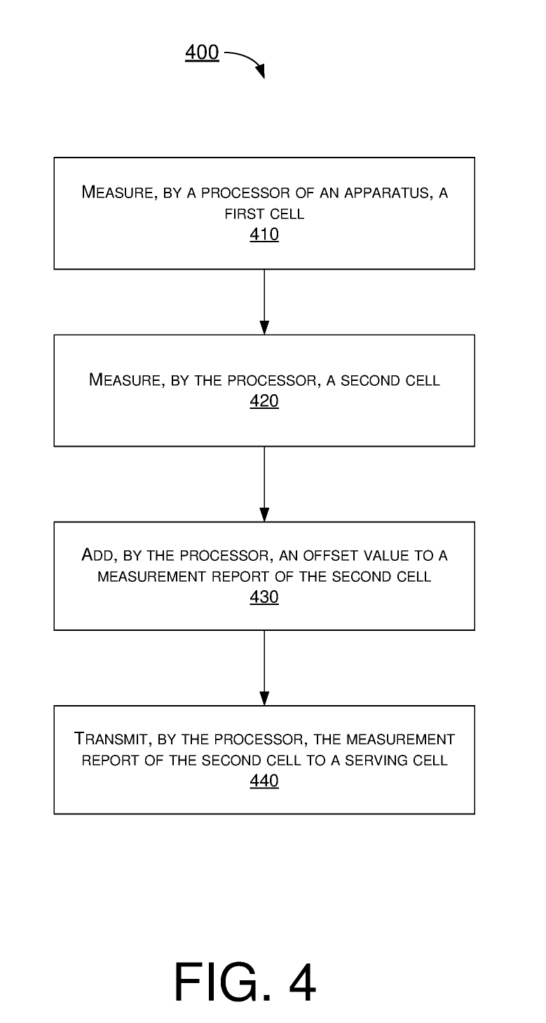

FIG. 4 illustrates an example process 400 in accordance with an implementation of the present disclosure. Process 400 may be an example implementation of scheme 200, whether partially or completely, with respect to selecting large-bandwidth cell in accordance with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 measuring a first cell. Process 400 may proceed from 410 to 420.

At 420, process 400 may involve processor 312 measuring a second cell. Process 400 may proceed from 420 to 430.

At 430, process 400 may involve processor 312 adding an offset value to a measurement report of the second cell. Process 400 may proceed from 430 to 440.

At 440, process 400 may involve processor 312 transmitting the measurement report of the second cell to a serving cell. A second bandwidth of the second cell may be greater than a first bandwidth of the first cell.

In some implementations, process 400 may involve processor 312 pending a measurement report of the first cell without transmitting the measurement report of the first cell to the serving cell.

In some implementations, the measurement report may comprise at least one of an A3 measurement report, an A4 measurement report, or an A5 measurement report.

In some implementations, process 400 may involve processor 312 determining the first bandwidth and the second bandwidth according to measurement bandwidths configured by the serving cell.

In some implementations, process 400 may involve processor 312 determining the first bandwidth and the second bandwidth according to pre-stored bandwidth information.

In some implementations, process 400 may involve processor 312 determining the first bandwidth and the second bandwidth according to a pre-determined measurement bandwidth.

In some implementations, process 400 may involve processor 312 determining the first bandwidth and the second bandwidth according to reference signals.

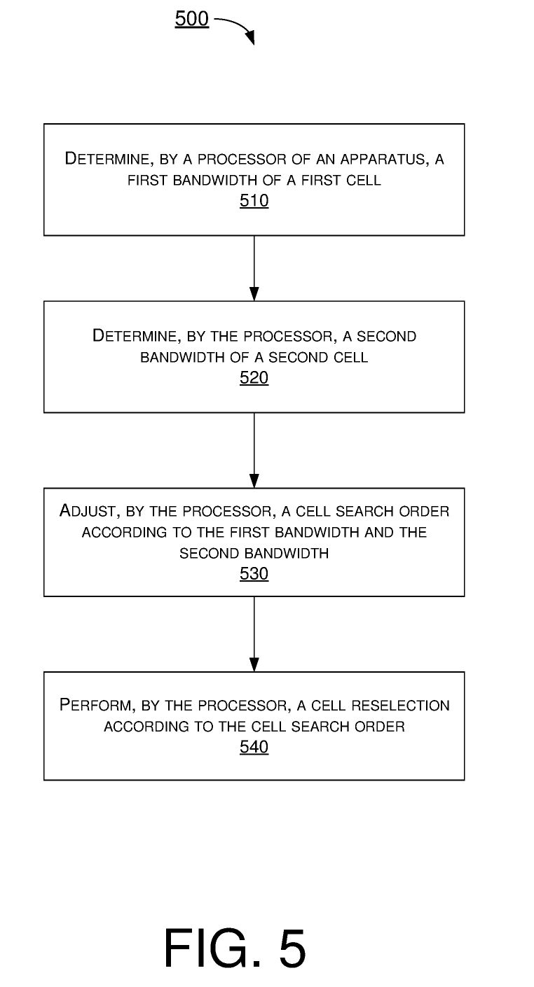

FIG. 5 illustrates an example process 500 in accordance with an implementation of the present disclosure. Process 500 may be an example implementation of scheme 200, whether partially or completely, with respect to selecting large-bandwidth cell in accordance with the present disclosure. Process 500 may represent an aspect of implementation of features of communication apparatus 310. Process 500 may include one or more operations, actions, or functions as illustrated by one or more of blocks 510, 520, 530 and 540. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of communication apparatus 310 determining a first bandwidth of a first cell. Process 500 may proceed from 510 to 520.

At 520, process 500 may involve processor 312 determining a second bandwidth of a second cell. Process 500 may proceed from 520 to 530.

At 530, process 500 may involve processor 312 adjusting a cell search order according to the first bandwidth and the second bandwidth. Process 500 may proceed from 530 to 540.

At 540, process 500 may involve processor 312 performing a cell selection according to the cell search order.

In some implementations, the second bandwidth may be greater than the first bandwidth. A priority of the second cell may be greater than a priority of the first cell when performing the cell selection.

In some implementations, process 500 may involve processor 312 pending a measurement report of the first cell without transmitting the measurement report of the first cell to the serving cell.

In some implementations, process 500 may involve processor 312 determining the first bandwidth and the second bandwidth according to measurement bandwidths configured by the serving cell.

In some implementations, process 500 may involve processor 312 determining the first bandwidth and the second bandwidth according to pre-stored bandwidth information.

In some implementations, process 500 may involve processor 312 determining the first bandwidth and the second bandwidth according to a pre-determined measurement bandwidth.

In some implementations, process 500 may involve processor 312 determining the first bandwidth and the second bandwidth according to reference signals.

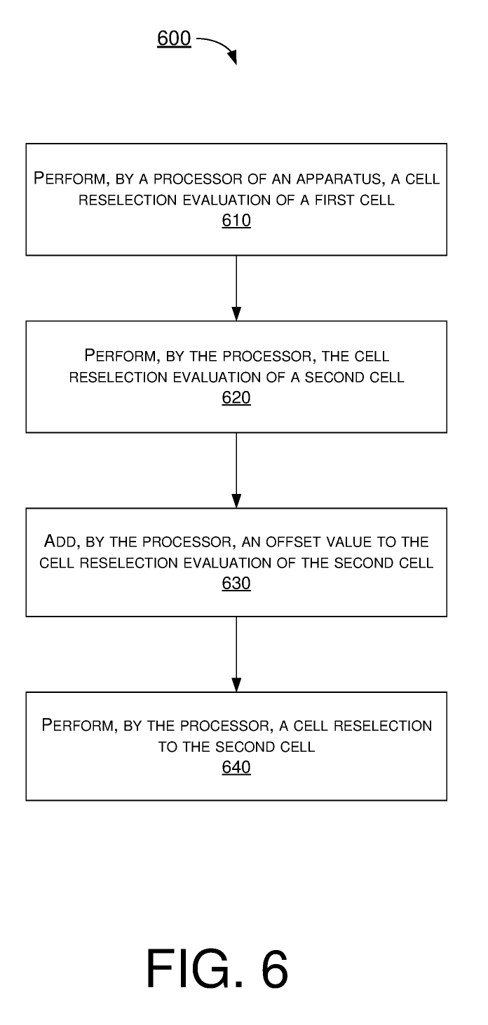

FIG. 6 illustrates an example process 600 in accordance with an implementation of the present disclosure. Process 600 may be an example implementation of scheme 200, whether partially or completely, with respect to selecting large-bandwidth cell in accordance with the present disclosure. Process 600 may represent an aspect of implementation of features of communication apparatus 310. Process 600 may include one or more operations, actions, or functions as illustrated by one or more of blocks 610, 620, 630 and 640. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 310 or any suitable UE or machine type devices. Solely for illustrative purposes and without limitation, process 600 is described below in the context of communication apparatus 310. Process 600 may begin at block 610.

At 610, process 600 may involve processor 312 of communication apparatus 310 performing a cell reselection evaluation of a first cell. Process 600 may proceed from 610 to 620.

At 620, process 600 may involve processor 312 performing the cell reselection evaluation of a second cell. Process 600 may proceed from 620 to 630.

At 630, process 600 may involve processor 312 adding an offset value to the cell reselection evaluation of the second cell. Process 600 may proceed from 630 to 640.

At 640, process 600 may involve processor 312 performing a cell reselection to the second cell. A second bandwidth of the second cell may be greater than a first bandwidth of the first cell.

In some implementations, process 600 may involve processor 312 pending the first cell without reselecting to the first cell.

In some implementations, the cell reselection evaluation may comprise an S-value evaluation.

In some implementations, process 600 may involve processor 312 determining the first bandwidth and the second bandwidth according to measurement bandwidths configured by the serving cell.

In some implementations, process 600 may involve processor 312 determining the first bandwidth and the second bandwidth according to pre-stored bandwidth information.

In some implementations, process 600 may involve processor 312 determining the first bandwidth and the second bandwidth according to a pre-determined measurement bandwidth.

In some implementations, process 600 may involve processor 312 determining the first bandwidth and the second bandwidth according to reference signals.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
measuring, by a processor of an apparatus, a first cell;
measuring, by the processor, a second cell;
adding, by the processor, an offset value to a measurement report of the second cell; and
transmitting, by the processor, the measurement report of the second cell to a serving cell,
wherein a second bandwidth of the second cell is greater than a first bandwidth of the first cell.

2. The method of claim 1, further comprising:
pending, by the processor, a measurement report of the first cell without transmitting the measurement report of the first cell to the serving cell.

3. The method of claim 1, wherein the measurement report comprises at least one of an A3 measurement report, an A4 measurement report, or an A5 measurement report.

4. The method of claim 1, further comprising:
determining, by the processor, the first bandwidth and the second bandwidth according to measurement bandwidths configured by the serving cell.

5. The method of claim 1, further comprising:
determining, by the processor, the first bandwidth and the second bandwidth according to pre-stored bandwidth information.

6. The method of claim 1, further comprising:
determining, by the processor, the first bandwidth and the second bandwidth according to a pre-determined measurement bandwidth.

7. The method of claim 1, further comprising:
determining, by the processor, the first bandwidth and the second bandwidth according to reference signals.

8. A method, comprising:
determining, by a processor of an apparatus, a first bandwidth of a first cell;
determining, by the processor, a second bandwidth of a second cell;
adjusting, by the processor, a cell search order according to the first bandwidth and the second bandwidth; and
performing, by the processor, a cell selection according to the cell search order.

9. The method of claim 8, wherein the second bandwidth is greater than the first bandwidth, and wherein a priority of the second cell is greater than a priority of the first cell when performing the cell selection.

10. The method of claim 8, further comprising:
determining, by the processor, the first bandwidth and the second bandwidth according to measurement bandwidths configured by a cell.

11. The method of claim 8, further comprising:
determining, by the processor, the first bandwidth and the second bandwidth according to pre-stored bandwidth information.

12. The method of claim 8, further comprising:
determining, by the processor, the first bandwidth and the second bandwidth according to a pre-determined measurement bandwidth.

13. The method of claim 8, further comprising:
determining, by the processor, the first bandwidth and the second bandwidth according to reference signals.

14. A method, comprising:
performing, by a processor of an apparatus, a cell reselection evaluation of a first cell;
performing, by the processor, the cell reselection evaluation of a second cell;
adding, by the processor, an offset value to the cell reselection evaluation of the second cell; and
performing, by the processor, a cell reselection to the second cell,
wherein a second bandwidth of the second cell is greater than a first bandwidth of the first cell.

15. The method of claim 14, further comprising:
pending, by the processor, the first cell without reselecting to the first cell.

16. The method of claim 14, wherein the cell reselection evaluation comprises an S-value evaluation.

17. The method of claim 14, further comprising:
determining, by the processor, the first bandwidth and the second bandwidth according to measurement bandwidths configured a cell.

18. The method of claim 14, further comprising:
determining, by the processor, the first bandwidth and the second bandwidth according to pre-stored bandwidth information.

19. The method of claim 14, further comprising:
determining, by the processor, the first bandwidth and the second bandwidth according to a pre-determined measurement bandwidth.

20. The method of claim 14, further comprising:
determining, by the processor, the first bandwidth and the second bandwidth according to reference signals.
